(19) United States
(12) Patent Application Publication
(10) Pub. No.: US 2010/0283703 A1
(43) Pub. Date: Nov. 11, 2010

(54) HIGH-GAIN MULTI-POLARIZATION ANTENNA ARRAY MODULE

(75) Inventor: Jun Zhi Chen, Taipei County (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: SMARTANT TELECOM CO., LTD., Hsinchu (TW)

(21) Appl. No.: 12/775,141

(22) Filed: May 6, 2010

(30) Foreign Application Priority Data
May 6, 2009 (TW) 098207762

(51) Int. Cl. H01Q 21/24; H01Q 1/42; H01Q 15/14

(52) U.S. Cl. 343/836; 343/893; 343/872

(57) ABSTRACT

A high-gain multi-polarization antenna array module includes an antenna array and a plurality of Butler matrixes. The antenna array includes four antennas, and each antenna includes two feed portions. Each Butler matrix includes four 90° hybrid couplers, two phase shifters, four input ports, and four output ports, and the four output ports are respectively electrically connected to the four different antennas. The antenna array module integrates multi-polarization array antennas and base station antennas generating beam forming by using the Butler matrixes, such that beam shapes generated by the antenna array may be deflected according to a set specific angle, thereby greatly improving receiving quality of the antennas.

### CROSS-REFERENCE TO RELATED APPLICATIONS

This non-provisional application claims priority under 35 U.S.C. §119(a) on Patent Application No(s). 098207762 filed in Taiwan, R.O.C. on May 6, 2009, the entire contents of which are hereby incorporated by reference.

### BACKGROUND OF THE INVENTION

1. Field of the Invention

The present invention relates to an antenna array module, and more particularly to a high-gain multi-polarization antenna array module.

2. Related Art

Antennas may be categorized into omnidirectional antennas and directional antennas. The omni-directional antenna radiates energy to all directions on a plane, while the directional antenna radiates energy to a specific angle range in a centralized manner. Therefore, compared with the omnidirectional antenna, the directional antenna has a larger antenna gain in the specific range. A conventional base station uses three directional antennas, and each directional antenna covers a sector range having a horizontal angle of 120°.

However, the directional antenna covering the sector range of 120° used by the conventional base station still has a problem of an excessively wide range. Due to the problem, only a small part of the energy may be correctly radiated to the direction of a user, so the energy is wasted. Meanwhile, most part of the redundant energy is radiated to other places, so as to interfere with other users.

In addition, the antenna unit adopted by the conventional base station is vertically polarized or horizontally polarized, but a mobile device used by a user habitually is at an angle of 45° with the ground. The antenna design of the conventional base station does not consider the habit of using the mobile device by the user, so the antenna gain is lowered, thereby affecting the communication transmission quality.

### SUMMARY OF THE INVENTION

In view of the above problems, the present invention is a high-gain multi-polarization antenna array module, capable of integrating multi-polarization array antennas and Butler matrixes to generate beam forming, in which beam shapes generated by an antenna array may be deflected according to a set specific angle, thereby greatly improving receiving quality of the antennas.

In an embodiment, the present invention provides a high-gain multi-polarization antenna array module, which comprises an antenna array, a first Butler matrix, and a second Butler matrix. The antenna array comprises four antennas, and each antenna comprises two feed portions. The first Butler matrix comprises four 90° hybrid couplers, two 45° phase shifters, four input ports and four output ports, and the four output ports are respectively electrically connected to the four different antennas. The second Butler matrix comprises four 90° hybrid couplers, two −45° phase shifters, four input ports and four output ports, and the four output ports are respectively electrically connected to the four different antennas.

In another embodiment, the present invention further provides a high-gain multi-polarization antenna array module, which comprises an antenna array, a first Butler matrix, a second Butler matrix, and a third Butler matrix. The first Butler matrix comprises four 90° hybrid couplers, two 45° phase shifters, four input ports and four output ports, and the four output ports are respectively electrically connected to the four different antennas. The second Butler matrix comprises four 90° hybrid couplers, two −45° phase shifters, four input ports and four output ports, and the four output ports are respectively electrically connected to the four different antennas. The third Butler matrix comprises four 90° hybrid couplers, two phase shifters, four input ports and four output ports, a phase shift angle of the phase shifters is any angle except for 45° and −45°, and the four output ports are respectively electrically connected to the four different antennas.

According to the embodiments of the present invention, the high-gain multi-polarization antenna array module according to the present invention may generate the beam forming having various different polarization directions centralized at a specific angle by using the plurality of Butler matrixes and one antenna array module.

### BRIEF DESCRIPTION OF THE DRAWINGS

The present invention will become more fully understood from the detailed description given herein below for illustration only, and thus are not limitative of the present invention, and wherein:

FIG. 1 is a block diagram of a high-gain multi-polarization antenna array module;

FIG. 2 is a schematic view of the implementation of a high-gain multi-polarization antenna array module;

FIG. 3 is a block diagram of Butler matrixes;

FIG. 4 is a block diagram of a high-gain multi-polarization antenna array module;

FIG. 5A is a pattern diagram of a first input port at a polarization direction of 45° and an operating frequency of 2400 MHz;

FIG. 5B is a pattern diagram of the first input port at the polarization direction of 45° and an operating frequency of 2450 MHz;

FIG. 5C is a pattern diagram of the first input port at the polarization direction of 45° and an operating frequency of 2500 MHz;

FIG. 6A is a pattern diagram of a second input port at a polarization direction of 45° and an operating frequency of 2400 MHz;

FIG. 6B is a pattern diagram of the second input port at the polarization direction of 45° and an operating frequency of 2450 MHz;

FIG. 6C is a pattern diagram of the second input port at the polarization direction of 45° and an operating frequency of 2500 MHz;

FIG. 7A is a pattern diagram of a third input port at a polarization direction of 45° and an operating frequency of 2400 MHz;

FIG. 7B is a pattern diagram of the third input port at the polarization direction of 45° and an operating frequency of 2450 MHz;

FIG. 7C is a pattern diagram of the third input port at the polarization direction of 45° and an operating frequency of 2500 MHz;

FIG. 8A is a pattern diagram of a fourth input port at a polarization direction of 45° and an operating frequency of 2400 MHz;

FIG. 8B is a pattern diagram of the fourth input port at the polarization direction of 45° and an operating frequency of 2450 MHz;

FIG. 8C is a pattern diagram of the fourth input port at the polarization direction of 45° and an operating frequency of 2500 MHz;

FIG. 9A is a pattern diagram of the first input port at a polarization direction of −45° and an operating frequency of 2400 MHz;

FIG. 9B is a pattern diagram of the first input port at the polarization direction of −45° and an operating frequency of 2450 MHz;

FIG. 9C is a pattern diagram of the first input port at the polarization direction of −45° and an operating frequency of 2500 MHz;

FIG. 10A is a pattern diagram of the second input port at a polarization direction of −45° and an operating frequency of 2400 MHz;

FIG. 10B is a pattern diagram of the second input port at the polarization direction of −45° and an operating frequency of 2450 MHz;

FIG. 10C is a pattern diagram of the second input port at the polarization direction of −45° and an operating frequency of 2500 MHz;

FIG. 11A is a pattern diagram of the third input port at a polarization direction of −45° and an operating frequency of 2400 MHz;

FIG. 11B is a pattern diagram of the third input port at the polarization direction of −45° and an operating frequency of 2450 MHz;

FIG. 11C is a pattern diagram of the third input port at the polarization direction of −45° and an operating frequency of 2500 MHz;

FIG. 12A is a pattern diagram of the fourth input port at a polarization direction of −45° and an operating frequency of 2400 MHz;

FIG. 12B is a pattern diagram of the fourth input port at the polarization direction of −45° and an operating frequency of 2450 MHz; and

FIG. 12C is a pattern diagram of the fourth input port at the polarization direction of −45° and an operating frequency of 2500 MHz.

### DETAILED DESCRIPTION OF THE INVENTION

The detailed features and advantages of the present invention are described below in great detail through the following embodiments, and the content of the detailed description is sufficient for those skilled in the art to understand the technical content of the present invention and to implement the present invention accordingly. Based upon the content of the specification, the claims, and the drawings, those skilled in the art can easily understand the relevant objectives and advantages of the present invention. The following embodiments are intended to describe the present invention in further detail, but not intended to limit the scope of the present invention in any way.

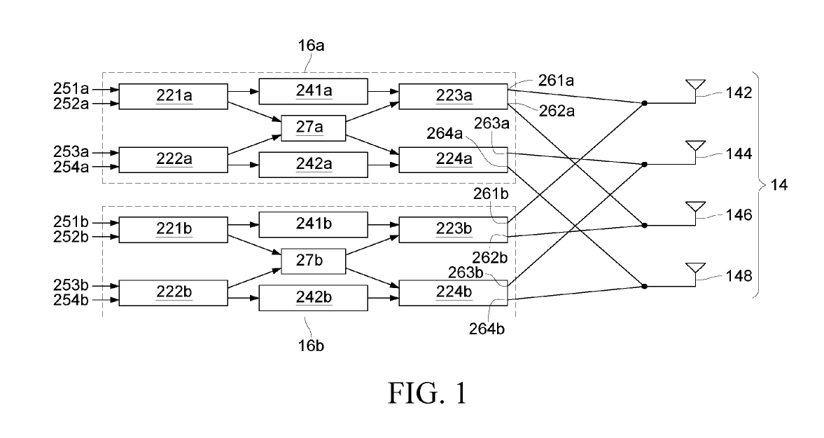

FIG. 1 is a schematic block diagram of a high-gain multi-polarization antenna array module according to an embodiment of the present invention. Referring to FIG. 1, the high-gain multi-polarization antenna array module comprises an antenna array 14, a first Butler matrix 16a, and a second Butler matrix 16b. In this embodiment, the antenna array comprises a first antenna 142, a second antenna 144, a third antenna 146, and a fourth antenna 148, and each antenna comprises two feed portions for feeding signals.

The first Butler matrix 16a comprises a first 90° hybrid coupler 221a, a second 90° hybrid coupler 222a, a third 90° hybrid coupler 223a, a fourth 90° hybrid coupler 224a, a first phase shifter 241a, a second phase shifter 242a, a first input port 251a, a second input port 252a, a third input port 253a, a fourth input port 254a, and a jumper 27a. The first 90° hybrid coupler 221a is electrically connected to the first phase shifter 241a, and the first phase shifter 241a is electrically connected to the third 90° hybrid coupler 223a. The second 90° hybrid coupler 222a is electrically connected to the second phase shifter 242a, and the second phase shifter 242a is electrically connected to the fourth 90° hybrid coupler 224a. In addition, the first 90° hybrid coupler 221a is electrically connected to the jumper 27a, the jumper 27a is electrically connected to the fourth 90° hybrid coupler 224a, the second 90° hybrid coupler 222a is electrically connected to the jumper 27a, and the jumper 27a is electrically connected to the third 90° hybrid coupler 223a. A phase shift angle of the first phase shifter 241a and the second phase shifter 241b is 45°. The second Butler matrix 16b comprises a first 90° hybrid coupler 221b, a second 90° hybrid coupler 222b, a third 90° hybrid coupler 223b, a fourth 90° hybrid coupler 224b, a first phase shifter 241b, a second phase shifter 242b, a first input port 251b, a second input port 252b, a third input port 253b, a fourth input port 254b, and a jumper 27b. A phase shift angle of the first phase shifter 241b and the second phase shifter 242b is −45°. The connection of the second Butler matrix 16b is the same as that of the first Butler matrix 16a.

The first Butler matrix 16a further comprises a first output port 261a, a second output port 262a, a third output port 263a, and a fourth output port 264a, and the second Butler matrix further comprises a first output port 261b, a second output port 262b, a third output port 263b, and a fourth output port 264b.

In the first Butler matrix 16a, the first output port 261a is electrically connected to the first antenna 142, the second output port 262a is electrically connected to the third antenna 146, the third output port 263a is electrically connected to the second antenna 144, and the fourth output port 264a is electrically connected to the fourth antenna 148. In the second Butler matrix 16b, the first output port 261b is electrically connected to the first antenna 142, the second output port 262b is electrically connected to the third antenna 146, the third output port 263b is electrically connected to the second antenna 144, and the fourth output port 264b is electrically connected to the fourth antenna 148.

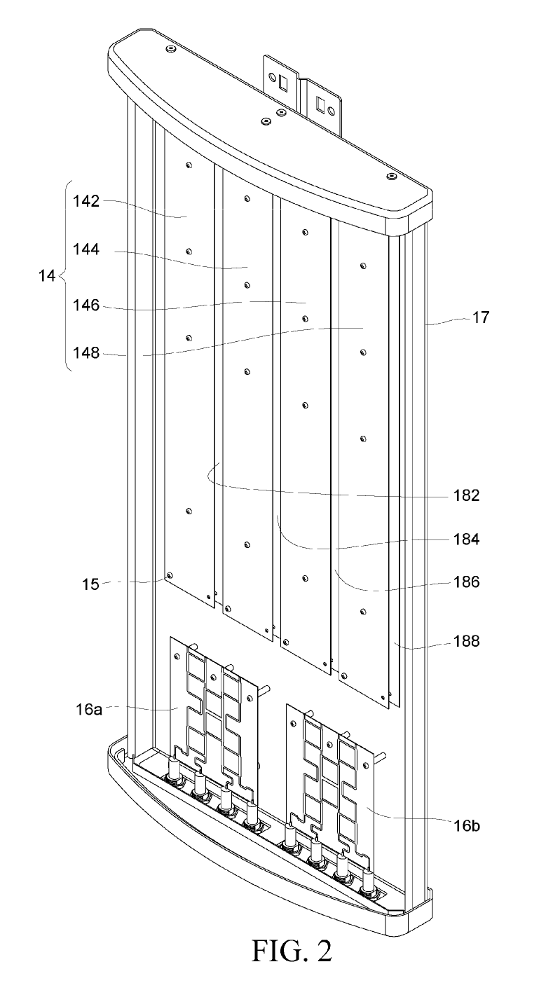

FIG. 2 is a schematic view of the implementation of a high-gain dual-polarization antenna array module according to an embodiment of the present invention, in which the antennas of FIG. 1 are applied to a base station. Referring to FIG. 2, the arrangement of the antenna array 14, the first Butler matrix 16a, and the second Butler matrix 16b is similar to the structure shown in FIG. 1. In this embodiment, the antenna array 14, the first Butler matrix 16a, and the second Butler matrix 16b are disposed in a case 17. The antenna array 14 further comprises a first antenna 142, a second antenna 144, a third antenna 146, and a fourth antenna 148. In this embodiment, the first antenna 142, the second antenna 144, the third antenna 146, and the fourth antenna 148 are rectangular antennas, but the present invention is not limited to the shape, and the antennas in other shapes may also be applied in the present invention. Each antenna has a reflecting plate correspondingly disposed thereon, and the reflecting plates are respectively a first reflecting plate 182, a second reflecting plate 184, a third reflecting plate 186, and a fourth reflecting plate 188. Each antenna and each reflecting plate are spaced at a preset distance. In principle, the reflecting plates are made of a metal material.

Each antenna and each reflecting plate may be fixed on the case 17 by using a plurality of support members 15. The support members 15 may be made of metal or other similar materials, and may adopt a screw fixing manner or other manners. In an embodiment of the present invention, the antennas are applied to the base station, so a cover (not shown) is used to cover the case.

The connection relations between the first Butler matrix 16a and the second Butler matrix 16b and the first antenna 142, the second antenna 144, the third antenna 146, and the fourth antenna 148, and the structure relations of the elements in the first Butler matrix 16a and the second Butler matrix 16b are as shown in the block diagram of FIG. 1. Here, it is too complicated to draw the connection and structure relations, so for the simplicity and clearness of illustration, the connection and structure relations are not shown. In this embodiment, the first Butler matrix 16a and the second Butler matrix 16b, and the first antenna 142, the second antenna 144, the third antenna 146, and the fourth antenna 148 are connected by copper wires or wires of other materials.

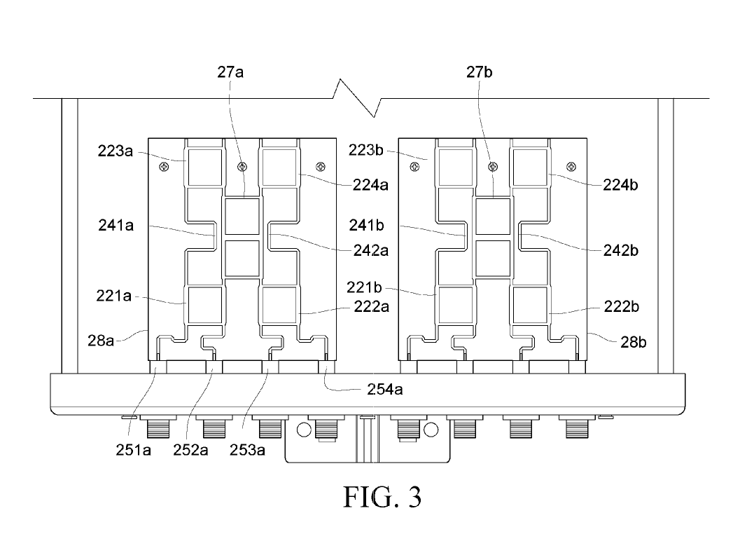

FIG. 3 is a schematic view of details of the Butler matrixes according to an embodiment of the present invention. The first Butler matrix 16a comprises a first 90° hybrid coupler 221a, a second 90° hybrid coupler 222a, a third 90° hybrid coupler 223a, a fourth 90° hybrid coupler 224a, a first phase shifter 241a, a second phase shifter 242a, a first input port 251a, a second input port 252a, a third input port 253a, a fourth input port 254a, and a jumper 27a. The second Butler matrix 16b comprises a first 90° hybrid coupler 221b, a second 90° hybrid coupler 222b, a third 90° hybrid coupler 223b, a fourth 90° hybrid coupler 224b, a first phase shifter 241b, a second phase shifter 242b, a first input port 251b, a second input port 252b, a third input port 253b, a fourth input port 254b, and a jumper 27b. In the hybrid couplers, a signal delivery circuit is designed as a square structure. The jumper 27a·27b is an 8-shape structure. In the first phase shifter 241a and the second phase shifter 242a of the first Butler matrix 16a, the signal delivery circuit has a bent design, such that 45° phase delay is performed on the phase of a signal. In the first phase shifter 241b and the second phase shifter 242b of the second Butler matrix 16b, the signal delivery circuit has another bent design, such that −45° phase delay is performed on the phase of a signal. The connection relations of the elements are as shown in FIG. 1. The first Butler matrix 16a uses a first circuit board 28a as a substrate, the second Butler matrix 16b uses a second circuit board 28b as a substrate, each element is disposed on the circuit board, and the elements are connected by metal lines or other elements capable of transmitting signals.

When an external signal is input to the first input port 251a of the first Butler matrix 16a, the polarization direction of the electromagnetic pattern generated by the antenna array is 45°, and the deflection angle is approximately −10°. When the external signal is input to the second input port 252a of the first Butler matrix 16a, the polarization direction of the electromagnetic pattern generated by the antenna array is 45°, and the deflection angle is approximately +30°. When the external signal is input to the third input port 253a of the first Butler matrix 16a, the polarization direction of the electromagnetic pattern generated by the antenna array is 45°, and the deflection angle is approximately −30°. When the external signal is input to the fourth input port 254a of the first Butler matrix 16a, the polarization direction of the electromagnetic pattern generated by the antenna array is 45°, and the deflection angle is approximately 10°. When the external signal is input to the first input port 251b of the second Butler matrix 16b, the polarization direction of the electromagnetic pattern generated by the antenna array is −45°, and the deflection angle is approximately −10°. When the external signal is input to the second input port 252b of the second Butler matrix 16b, the polarization direction of the electromagnetic pattern generated by the antenna array is −45°, and the deflection angle is approximately +30°. When the external signal is input to the third input port 253b of the second Butler matrix 16b, the polarization direction of the electromagnetic pattern generated by the antenna array is −45°, and the deflection angle is approximately −30°. When the external signal is input to the fourth input port 254b of the second Butler matrix 16b, the polarization direction of the electromagnetic pattern generated by the antenna array is −45°, and the deflection angle is approximately 10°. The deflection angles and the polarization directions in this embodiment are only used for illustration, and the present invention is not thus limited. Persons of ordinary skill in the art may design different deflection angles and polarization directions according to the spirit of the present invention.

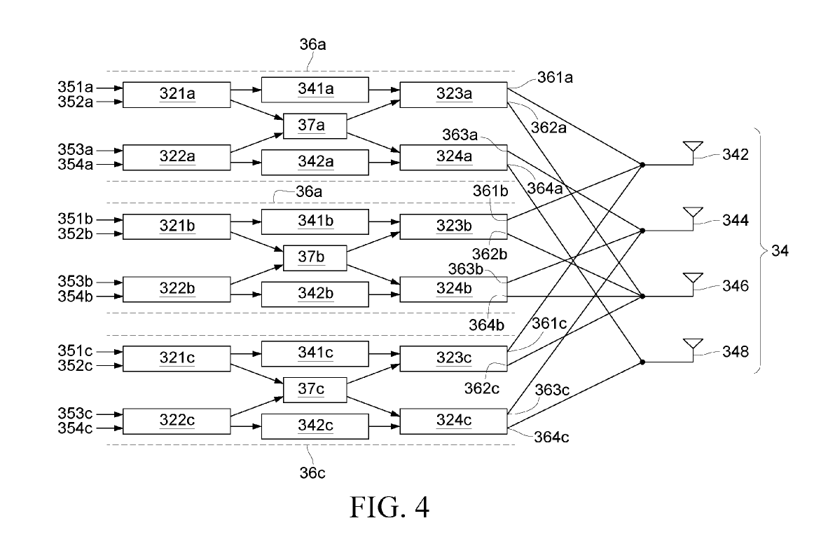

Further, FIG. 4 is a block diagram of a high-gain tri-polarization antenna array module according to another embodiment of the present invention. Referring to FIG. 4, the high-gain tri-polarization antenna array module comprises an antenna array 34, a first Butler matrix 36a, a second Butler matrix 36b, and a third Butler matrix 36c. The antenna array further comprises a first antenna 342, a second antenna 344, a third antenna 346, and a fourth antenna 348.

In the first Butler matrix 36a, a first output port 361a is electrically connected to the first antenna 342, a second output port 362a is electrically connected to the third antenna 346, a third output port 363a is electrically connected to the second antenna 344, and a fourth output port 364a is electrically connected to the fourth antenna 348. In the second Butler matrix 36b, a first output port 361b is electrically connected to the first antenna 342, a second output port 362b is electrically connected to the third square antenna 346, a third output port 363b is electrically connected to the second square antenna 344, and a fourth output port 364b is electrically connected to the fourth antenna 348. In the third Butler matrix 36c, a first output port 361c is electrically connected to the first antenna 342, a second output port 362c is electrically connected to the third antenna 346, a third output port 363c is electrically connected to the second antenna 344, and a fourth output port 364c is electrically connected to the fourth antenna 348.

The first Butler matrix 36a comprises a first 90° hybrid coupler 321a, a second 90° hybrid coupler 322a, a third 90° hybrid coupler 323a, a fourth 90° hybrid coupler 324a, a first phase shifter 341a, a second phase shifter 342a, a first input port 351a, a second input port 352a, a third input port 353a, a fourth input port 354a, and a jumper 37a. The first 90° hybrid coupler 321a is electrically connected to the first phase shifter 341a, and the first phase shifter 341a is electrically connected to the third 90° hybrid coupler 323a. The second 90° hybrid coupler 322a is electrically connected to the second phase shifter 342a, and the second phase shifter 342a is electrically connected to the fourth 90° hybrid coupler 324a. In addition, the first 90° hybrid coupler 321a is electrically connected to the jumper 37a, the jumper 37a is electrically connected to the fourth 90° hybrid coupler 324a, the second 90° hybrid coupler 322a is electrically connected to the jumper 37a, and the jumper 37a is electrically connected to the third 90° hybrid coupler 323a. The second Butler matrix further comprises a first 90° hybrid coupler 321b, a second 90° hybrid coupler 322b, a third 90° hybrid coupler 323b, a fourth 90° hybrid coupler 324b, a first phase shifter 341b, a second phase shifter 342b, a first input port 351b, a second input port 352b, a third input port 353b, a fourth input port 354b, and a jumper 37b. The third Butler matrix further comprises a first 90° hybrid coupler 321c, a second 90° hybrid coupler 322c, a third 90° hybrid coupler 323c, a fourth 90° hybrid coupler 324c, a first phase shifter 341c, a second phase shifter 342c, a first input port 351c, a second input port 352c, a third input port 353c, a fourth input port 354c, and a jumper 37c. The connection relations of the elements of the second Butler matrix and the third Butler matrix are the same as that of the first Butler matrix. A phase shift angle of the first phase shifter 341a and the second phase shifter 342a of the first Butler matrix 36a is 45°, a phase shift angle of the first phase shifter 341b and the second phase shifter 342b of the second Butler matrix 36b is −45°, and a phase shift angle of the first phase shifter 341c and the second phase shifter 342c of the third Butler matrix 36c is any angle except for 45° and −45°.

When an external signal is input to the first input port 351a of the first Butler matrix 36a, the polarization direction of the electromagnetic pattern generated by the antenna array is 45°, and the deflection angle is approximately −10°. When the external signal is input to the second input port 352a of the first Butler matrix 36a, the polarization direction of the electromagnetic pattern generated by the antenna array is 45°, and the deflection angle is approximately +30°. When the external signal is input to the third input port 353a of the first Butler matrix 36a, the polarization direction of the electromagnetic pattern generated by the antenna array is 45°, and the deflection angle is approximately −30°. When the external signal is input to the fourth input port 354a of the first Butler matrix 36a, the polarization direction of the electromagnetic pattern generated by the antenna array is 45°, and the deflection angle is approximately 10°. When the external signal is input to the first input port 351b of the second Butler matrix 36b, the polarization direction of the electromagnetic pattern generated by the antenna array is −45°, and the deflection angle is approximately −10°. When the external signal is input to the second input port 352b of the second Butler matrix 36b, the polarization direction of the electromagnetic pattern generated by the antenna array is −45°, and the deflection angle is approximately +30°. When the external signal is input to the third input port 353b of the second Butler matrix 36b, the polarization direction of the electromagnetic pattern generated by the antenna array is −45°, and the deflection angle is approximately −30°. When the external signal is input to the fourth input port 354b of the second Butler matrix 36b, the polarization direction of the electromagnetic pattern generated by the antenna array is an angle except for −45° or 45°, and the deflection angle is approximately 10°. When the external signal is input to the first input port 351c of the third Butler matrix 36c, the polarization direction of the electromagnetic pattern generated by the antenna array is an angle except for −45° or 45°, and the deflection angle is approximately −10°. When the external signal is input to the second input port 352c of the third Butler matrix 36c, the polarization direction of the electromagnetic pattern generated by the antenna array is an angle except for −45° or 45°, and the deflection angle is approximately +30°. When the external signal is input to the third input port 353c of the third Butler matrix 36c, the polarization direction of the electromagnetic pattern generated by the antenna array is an angle except for −45°or 45°, and the deflection angle is approximately −30°. When the external signal is input to the fourth input port 354c of the third Butler matrix 36c, the polarization direction of the electromagnetic pattern generated by the antenna array is −45°, and the deflection angle is approximately 10°.

In a preferred embodiment of the present invention, the four input ports are electrically connected to a switcher for being switched by the switcher, such that the antenna array is switched among beam forming of different angles. In another preferred embodiment of the present invention, a range of an operating frequency of the antenna array is from 2400 MHz to 2500 MHz.

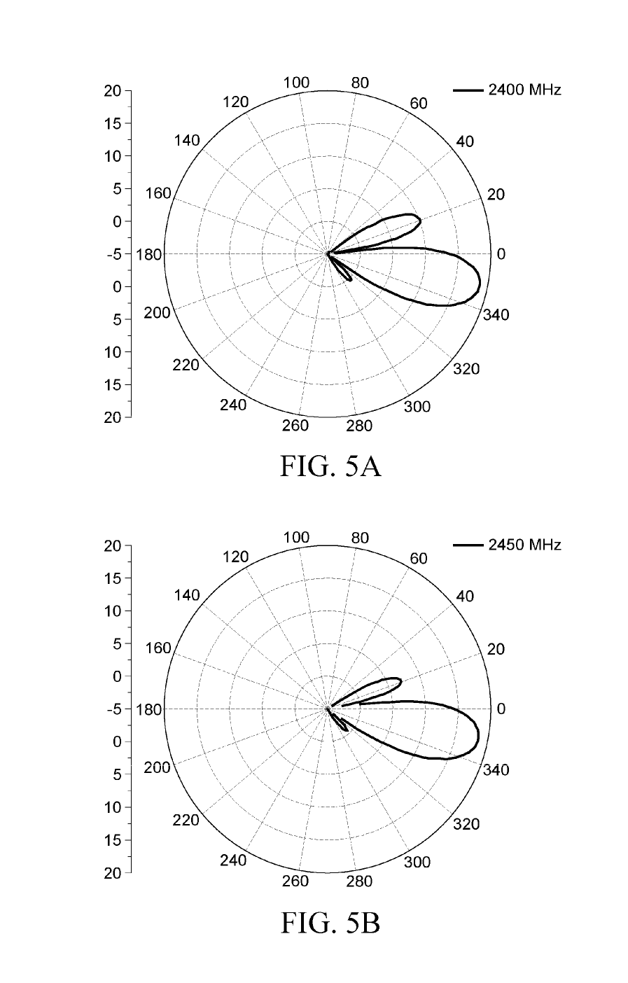

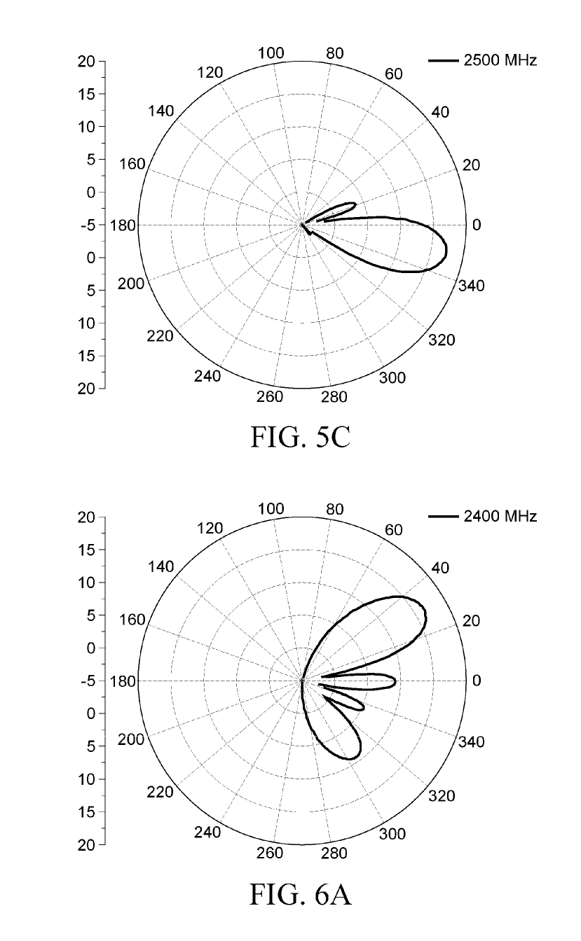

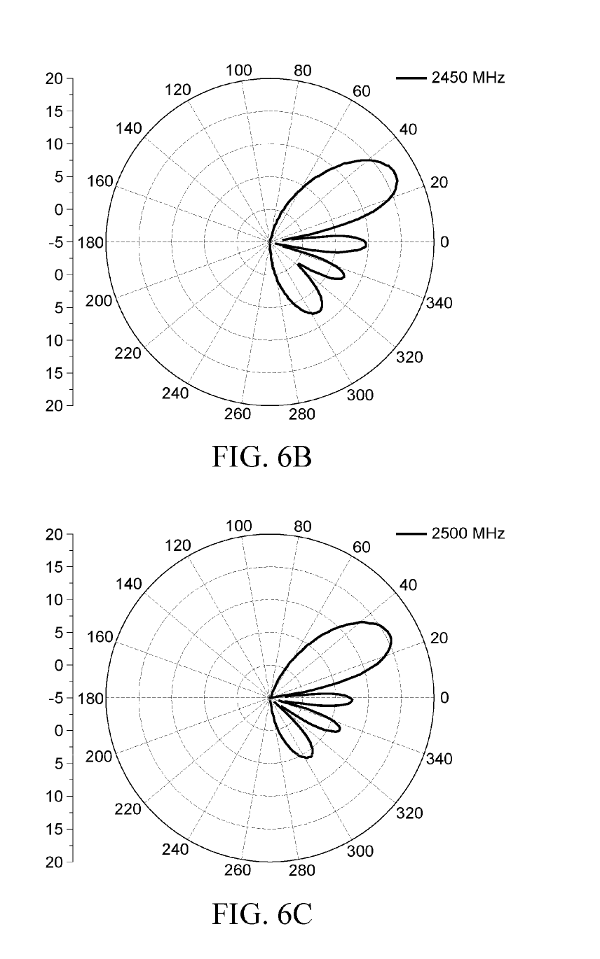

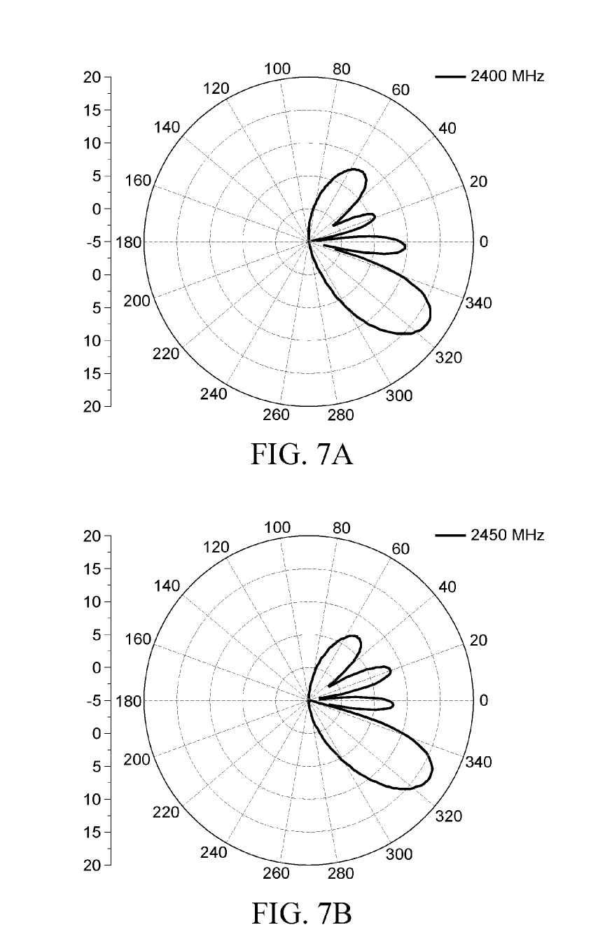

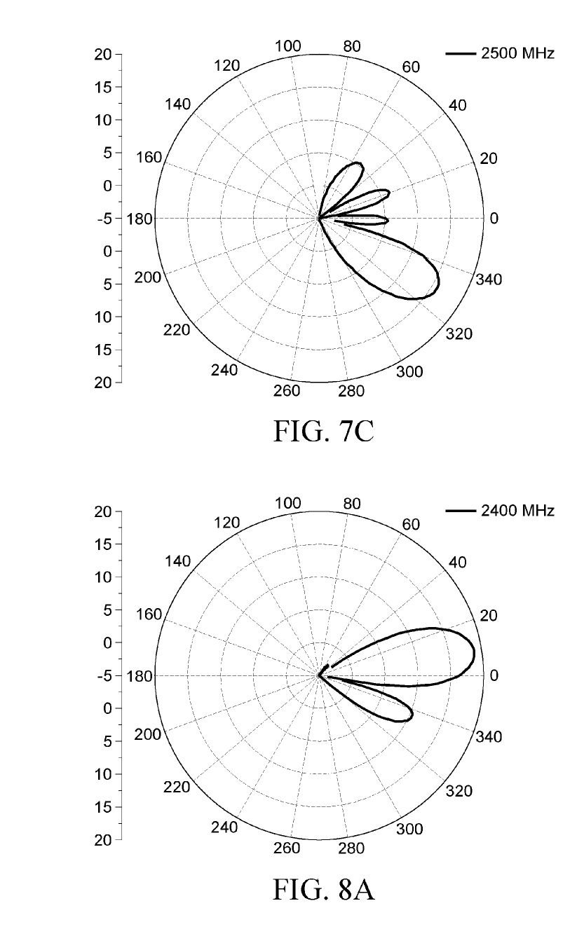

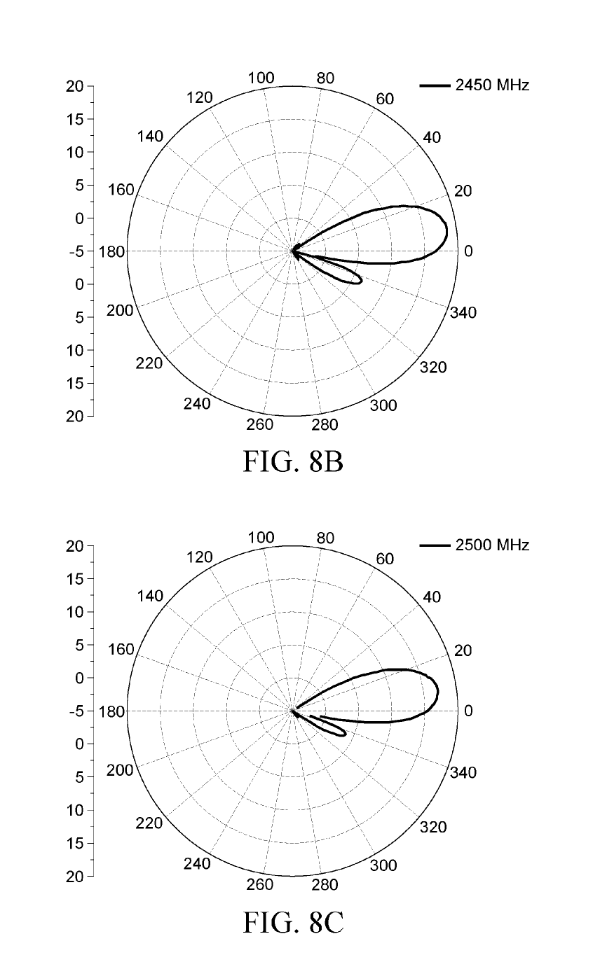

FIGS. 5A, 5B, and 5C are respectively radiation patterns generated by the antenna array at the operating frequencies of 2400 MHz, 2450 MHz, and 2500 MHz and the polarization direction of 45°, when the signal is fed through the first input port 251a of the first Butler matrix 16a in FIG. 1. FIGS. 6A, 6B, and 6C are respectively radiation patterns generated by the antenna array at the operating frequencies of 2400 MHz, 2450 MHz, and 2500 MHz and the polarization direction of 45°, when the signal is fed through the second input port 252a of the first Butler matrix 16a in FIG. 1. FIGS. 7A, 7B, and 7C are respectively radiation patterns generated by the antenna array at the operating frequencies of 2400 MHz, 2450 MHz, and 2500 MHz and the polarization direction of 45°, when the signal is fed through the third input port 253a of the first Butler matrix 16a in FIG. 1. FIGS. 8A, 8B, and 8C are respectively radiation patterns generated by the antenna array at the operating frequencies of 2400 MHz, 2450 MHz, and 2500 MHz and the polarization direction of 45°, when the signal is fed through the fourth input port 254a of the first Butler matrix 16a in FIG. 1.

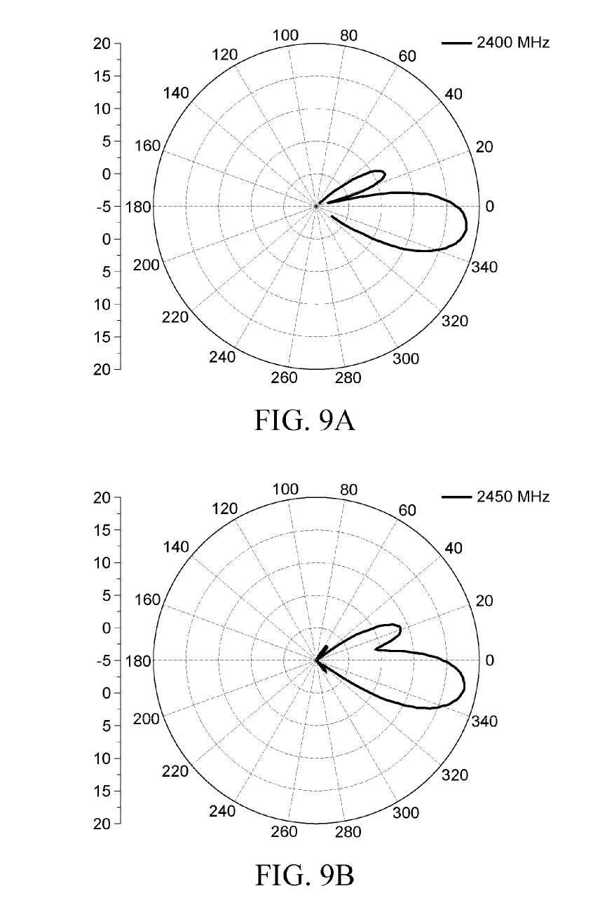

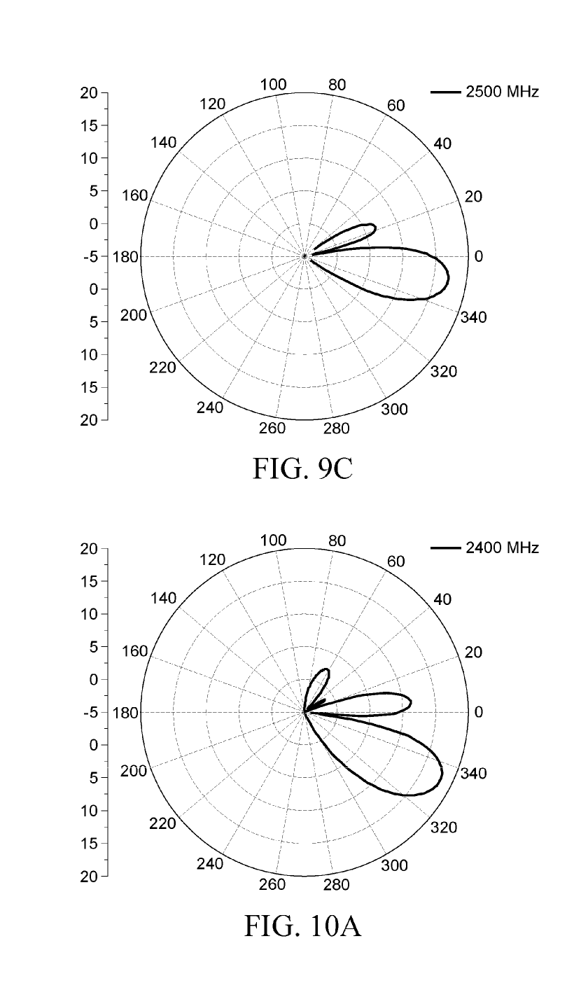

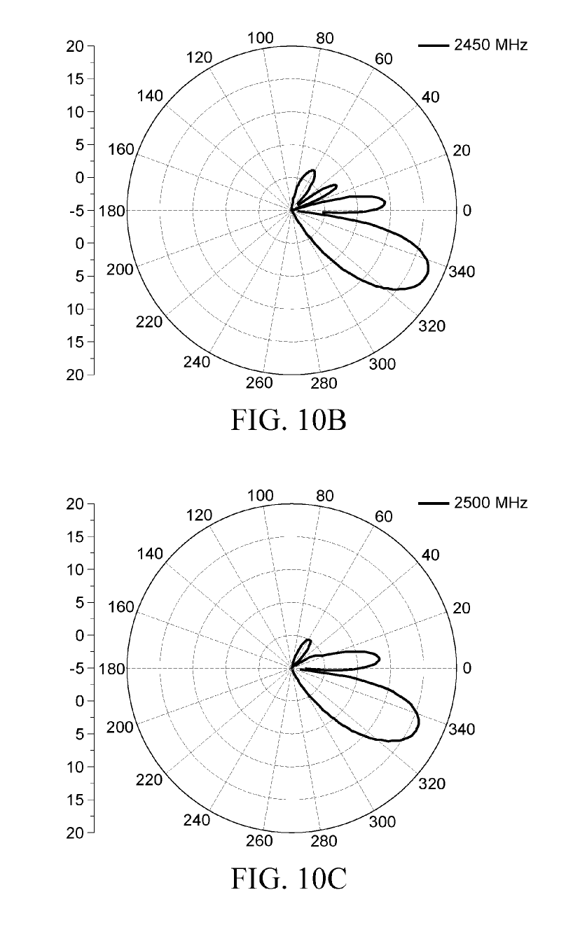

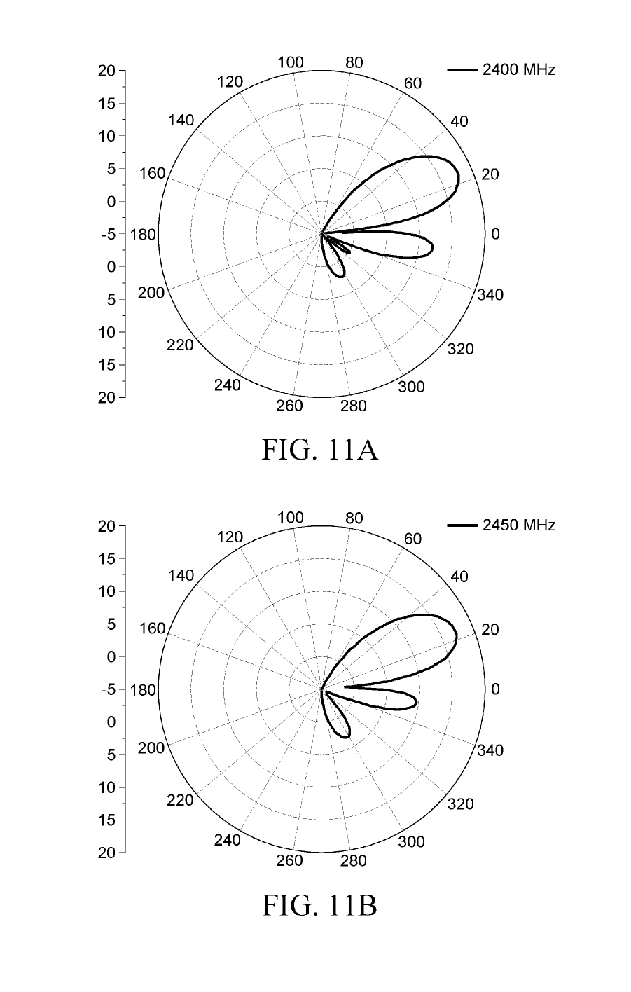

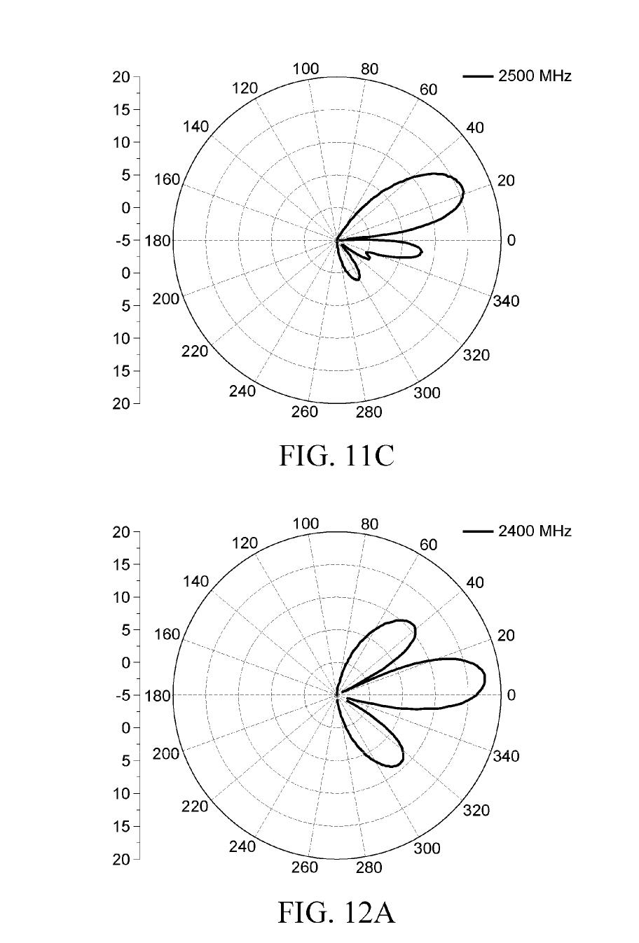

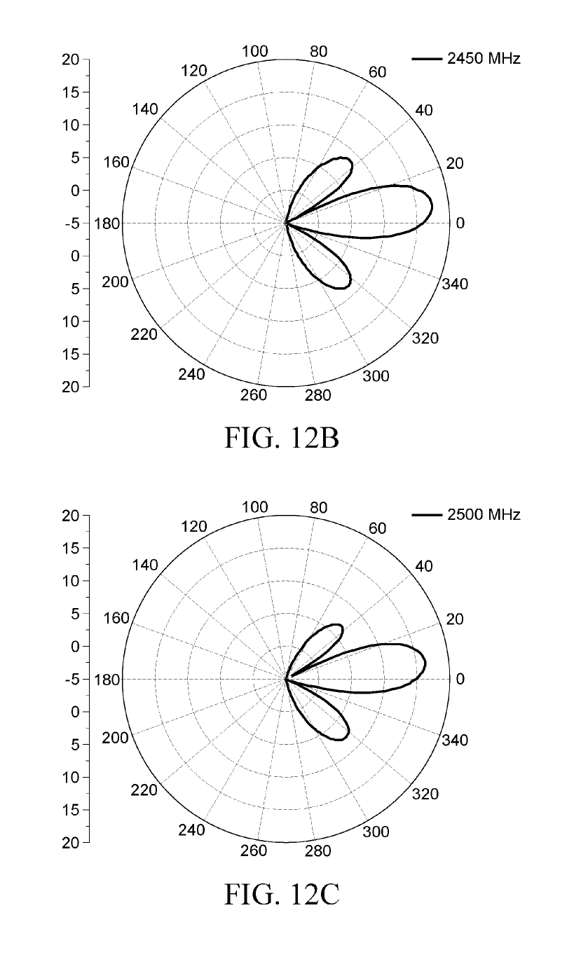

FIGS. 9A, 9B, and 9C are respectively radiation patterns generated by the antenna array at the operating frequencies of 2400 MHz, 2450 MHz, and 2500 MHz and the polarization direction of −45°, when the signal is fed through the first input port 251b of the second Butler matrix 16b in FIG. 1. FIGS. 10A, 10B, and 10C are respectively radiation patterns generated by the antenna array at the operating frequencies of 2400 MHz, 2450 MHz, and 2500 MHz and the polarization direction of −45°, when the signal is fed through the second input port 252b of the second Butler matrix 16b in FIG. 1. FIGS. 11A, 11B, and 11C are respectively radiation patterns generated by the antenna array at the operating frequencies of 2400 MHz, 2450 MHz, and 2500 MHz and the polarization direction of −45°, when the signal is fed through the third input port 253b of the second Butler matrix 16b in FIG. 1. FIGS. 12A, 12B, and 12C are respectively radiation patterns generated by the antenna array at the operating frequencies of 2400 MHz, 2450 MHz, and 2500 MHz and the polarization direction of −45°, when the signal is fed through the fourth input port 254b of the second Butler matrix 16b in FIG. 1.

What is claimed is:

1. A high-gain multi-polarization antenna array module, comprising:
an antenna array, comprising a first antenna, a second antenna, a third antenna, and a fourth antenna, wherein each of the antennas comprises two feed portions, and the feed portion is used for feeding an input signal;
a first Butler matrix, comprising four 90° hybrid couplers, two 45° phase shifters, four input ports, and four output ports, wherein the four output ports are respectively electrically connected to the first antenna, the second antenna, the third antenna, and the fourth antenna; and
a second Butler matrix, comprising four 90° hybrid couplers, two −45° phase shifters, four input ports, and four output ports, wherein the four output ports are respectively electrically connected to the four different antennas.

2. The multi-polarization antenna array module according to claim 1, wherein when an external signal is input to the first Butler matrix, a polarization direction of an electromagnetic pattern generated by the antenna array is 45°, and when the external signal input is input to the second Butler matrix, a polarization direction of an electromagnetic pattern generated by the antenna array is −45°.

3. The multi-polarization antenna array module according to claim 1, further comprising a case, wherein the antenna array, the first Butler matrix, and the second Butler matrix are disposed on the case.

4. The multi-polarization antenna array module according to claim 3, further comprising a cover, used to cover the case.

5. The multi-polarization antenna array module according to claim 3, further comprising a first reflecting plate, a second reflecting plate, a third reflecting plate, and a fourth reflecting plate.

6. The multi-polarization antenna array module according to claim 5, wherein the four reflecting plates use a metal material.

7. The multi-polarization antenna array module according to claim 5, further comprising a plurality of support members, wherein each of the antennas and each of the reflecting plates are fixed on the case by the plurality of support members.

8. The multi-polarization antenna array module according to claim 2, wherein when the external signal is input to the first input port of the first Butler matrix, the polarization direction of the electromagnetic pattern generated by the antenna array is 45°, and a deflection angle is −10°, when the external signal is input to the second input port of the first Butler matrix, the polarization direction of the electromagnetic pattern generated by the antenna array is 45°, and the deflection angle is +30°, when the external signal is input to the third input port of the first Butler matrix, the polarization direction of the electromagnetic pattern generated by the antenna array is 45°, and the deflection angle is −30°, and when the external signal is input to the fourth input port of the first Butler matrix, the polarization direction of the electromagnetic pattern generated by the antenna array is 45°, and the deflection angle is 10°.

9. The multi-polarization antenna array module according to claim 2, wherein when the external signal is input to the first input port of the second Butler matrix, the polarization direction of the electromagnetic pattern generated by the antenna array is −45°, and a deflection angle is −10°, when the external signal is input to the second input port of the second Butler matrix, the polarization direction of the electromagnetic pattern generated by the antenna array is −45°, and the deflection angle is +30°, when the external signal is input to the third input port of the second Butler matrix, the polarization direction of the electromagnetic pattern generated by the antenna array is −45°, and the deflection angle is −30°, and when the external signal is input to the fourth input port of the second Butler matrix, the polarization direction of the electromagnetic pattern generated by the antenna array is −45°, and the deflection angle is 10°.

10. The multi-polarization antenna array module according to claim 1, wherein the input port is electrically connected to a switcher for being switched by the switcher, such that the antenna array is switched among beam forming of different angles.

11. The multi-polarization antenna array module according to claim 1, wherein a range of an operating frequency of the antenna array is from 2400 MHz to 2500 MHz.

12. A high-gain multi-polarization antenna array module, comprising:
an antenna array, comprising a first antenna, a second antenna, a third antenna, and a fourth antenna, wherein each of the antennas comprises two feed portions, and the feed portion is used for feeding an input signal;
a first Butler matrix, comprising four 90° hybrid couplers, two 45° phase shifters, four input ports, and four output ports, wherein the four output ports are respectively electrically connected to the four different antennas;
a second Butler matrix, comprising four 90° hybrid couplers, two −45° phase shifters, four input ports, and four output ports, wherein the four output ports are respectively electrically connected to the four different antennas; and
a third Butler matrix, comprising four 90° hybrid couplers, two phase shifters, four input ports, and four output ports, wherein an angle of the phase shifters is an angle except for 45° and −45°, and the four output ports are respectively electrically connected to the four different antennas.

13. The multi-polarization antenna array module according to claim 12, wherein when an external signal is input to the different Butler matrixes, the antenna array generates different polarization directions of an electromagnetic pattern, and an angle of the polarization direction is a phase shift amount of the phase shifter.

14. The multi-polarization antenna array module according to claim 12, further comprising a case, wherein the antenna array, the first Butler matrix, and the second Butler matrix are disposed on the case.

15. The multi-polarization antenna array module according to claim 14, further comprising a cover, for covering the case.

16. The multi-polarization antenna array module according to claim 14, further comprising a first reflecting plate, a second reflecting plate, a third reflecting plate, and a fourth reflecting plate.

17. The multi-polarization antenna array module according to claim 16, wherein the four reflecting plates use a metal material.

18. The multi-polarization antenna array module according to claim 16, wherein each of the antennas and each of the reflecting plates are fixed on the case by a plurality of support members.

19. The multi-polarization antenna array module according to claim 13, wherein when the external signal is input to a first input port of the first Butler matrix, the polarization direction of the electromagnetic pattern generated by the antenna array is 45°, and a deflection angle is −10°, when the external signal is input to a second input port of the first Butler matrix, the polarization direction of the electromagnetic pattern generated by the antenna array is 45°, and the deflection angle is +30°, when the external signal is input to a third input port of the first Butler matrix, the polarization direction of the electromagnetic pattern generated by the antenna array is 45°, and the deflection angle is −30°, and when the external signal is input to a fourth input port of the first Butler matrix, the polarization direction of the electromagnetic pattern generated by the antenna array is 45°, and the deflection angle is 10°.

20. The multi-polarization antenna array module according to claim 13, wherein when the external signal is input to a first input port of the second Butler matrix, the polarization direction of the electromagnetic pattern generated by the antenna array is −45°, and a deflection angle is −10°, when the external signal is input to a second input port of the second Butler matrix, the polarization direction of the electromagnetic pattern generated by the antenna array is −45°, and the deflection angle is +30°, when the external signal is input to a third input port of the second Butler matrix, the polarization direction of the electromagnetic pattern generated by the antenna array is −45°, and the deflection angle is −30°, and when the external signal is input to a fourth input port of the second Butler matrix, the polarization direction of the electromagnetic pattern generated by the antenna array is −45°, and the deflection angle is 10°.

21. The multi-polarization antenna array module according to claim 13, wherein when the external signal is input to a first input port of the third Butler matrix, the polarization direction of the electromagnetic pattern generated by the antenna array is an angle except for −45° or 45°, and a deflection angle is −10°, when the external signal is input to a second input port of the third Butler matrix, the polarization direction of the electromagnetic pattern generated by the antenna array is an angle except for −45° or 45°, and the deflection angle is +30°, when the external signal is input to a third input port of the third Butler matrix, the polarization direction of the electromagnetic pattern generated by the antenna array is an angle except for −45° or 45°, and the deflection angle is −30°, and when the external signal is input to a fourth input port of the third Butler matrix, the polarization direction of the electromagnetic pattern generated by the antenna array is an angle except for −45° or 45°, and the deflection angle is 10°.

22. The multi-polarization antenna array module according to claim 12, wherein the input port is electrically connected to a switcher for being switched by the switcher, such that the antenna array is switched among beam forming of different angles.

23. The multi-polarization antenna array module according to claim 12, wherein a range of an operating frequency of the antenna array is from 2400 MHz to 2500 MHz.
